(19) United States
(12) Patent Application Publication
(10) Pub. No.: US 2024/0208559 A1
(43) Pub. Date: Jun. 27, 2024

(54) STROLLER FRAME STRUCTURE

(71) Applicant: Guangdong Lemeida Group Co. Ltd., Zhongshan (CN)

(72) Inventor: Bowen Yang, Taiwan (CN)

(21) Appl. No.: 18/390,913

(22) Filed: Dec. 20, 2023

(30) Foreign Application Priority Data
Dec. 21, 2022 (CN) 202211648490.7

(51) Int. Cl. B62B 7/06; B62B 9/20

(52) U.S. Cl. CPC B62B 7/06; B62B 9/20

(57) ABSTRACT

In the present invention, a stroller frame structure is disclosed, including a main frame, a seat assembly, a handle. Both the seat assembly and the handle are disposed on the main frame. The main frame has an unfolded state and a folded state, and is connected to a front wheel group and a rear wheel group. The main frame includes a first support surface and a second support surface. The second support surface is lower than the first support surface, to form a ridable structure having a height difference. The main frame is used for forming a seat for a child to ride on, and a size of the stroller is smaller than a size of a conventional double stroller, to facilitate moving in small space or a place with dense people. The handle is moved to a push position or a pull position, to implement functions of pushing and pulling the stroller. The main frame is of a foldable structure, to facilitate storage and carrying of the stroller.

### FIELD OF THE INVENTION

The present invention is related to the field of strollers, and in particular, to a stroller frame structure.

### BACKGROUND OF THE INVENTION

Currently, children's trailers on the market are mostly models with at least two seats, and the two seats are configured on a same plane. Although this can satisfy a need of a plurality of children to ride on and a larger cargo space during shopping, a large size trailer is not easy to move in a place where the space is smaller, and the size of this type of trailer is still large after folding, so that the trailer is not easy to carry. In addition, most of the trailers can only be used in a towed manner, and are less convenient to push.

### SUMMARY OF THE INVENTION

The present invention aims to resolve at least one of the technical problems existing in the conventional technologies. Therefore, in the present invention, a stroller frame structure is disclosed, and can reduce a size of a stroller.

In the present invention, another stroller frame structure is disclosed, and can implement functions of a trolley and a trailer.

In the present invention, a stroller frame structure is disclosed, and can implement frame folding, to facilitate storage and carrying.

According to an embodiment of a first aspect of the present invention, a stroller frame structure includes a main frame, a seat assembly, and a handle. Both the seat assembly and the handle are disposed on the main frame. The main frame has an unfolded state and a folded state, and is connected to a front wheel group and a rear wheel group. The main frame includes a first support surface and a second support surface. The second support surface is lower than the first support surface, to form a ridable structure having a height difference.

According to this embodiment of the present invention, the stroller frame structure has at least the following beneficial effects: The main frame is used for forming a seat for a child to ride on. Compared with a conventional double stroller, a size of the stroller frame structure is smaller to facilitate moving in small space or a place with dense people.

In some embodiments of the present invention, the handle is movably disposed on the main frame, and the handle slides along the main frame to a push position and a pull position; or the handle is detachably disposed on the main frame to enable the handle to change a position between a push position and a pull position.

In some embodiments of the present invention, the push position is close to the rear wheel group, and the pull position is close to the front wheel group.

In some embodiments of the present invention, the main frame has accommodating space. The accommodating space includes a bottom frame and a main body tube. The main body tube approaches the bottom frame in a folded state, to enable the main frame to be in the folded state.

In some embodiments of the present invention, the seat assembly is located in front of the first support surface for a first child to ride on. The first support surface is for a second child to ride on.

In some embodiments of the present invention, the seat assembly is detachably disposed on a main body tube of the main frame, and is mounted at a first position or a second position along the main body tube.

In some embodiments of the present invention, the first position of the seat assembly is located at a middle position between the front wheel group and the rear wheel group. The second position is close to the front wheel group, to enable the first support surface to be for a second child to ride on.

In some embodiments of the present invention, the main frame includes a third support surface for a child to step on. The third support surface is located at a leading edge of the main frame or a position close to the second support surface.

In some embodiments of the present invention, the main frame forms accommodating space, where the first support surface and the second support surface form a bottom of the accommodating space together; and/or the main frame includes a main body tube and a rear end frame, one end of the main body tube is connected to the second support surface, and the other end of the main body tube is connected to the first support surface through the rear end frame.

According to an embodiment of a second aspect of the present invention, a stroller frame structure includes a main frame, a seat assembly, and a handle. The seat assembly is disposed on the main frame. The main frame has an unfolded state and a folded state and is connected to a front wheel group and a rear wheel group. The main frame includes accommodating space. The handle is moved to a push position close to the rear wheel group and to a pull position close to the front wheel group.

According to an embodiment of the present invention, the stroller frame structure has at least the following beneficial effects: Functions of pushing the stroller and pulling the stroller can be implemented separately.

In some embodiments of the present invention, the handle is located between the push position and the pull position and is slidable along the main frame, and the handle rotates relative to the main frame; or the handle is detachably disposed at the push position or the pull position. In some embodiments of the present invention, the main frame includes a main body tube located on both sides of the main frame. The handle is moved between the push position and the pull position along the main body tube.

When the handle is located at the push position, the handle is locked to prevent rotation relative to the main frame.

When the handle is located at the pull position, the handle is unlocked to allow rotation relative to the main frame.

In some embodiments of the present invention, the handle is slidingly connected to the main body tube by sliding members in a position-limitable manner. The handle is rotatably connected to the sliding members in a rotation-lockable manner.

In some embodiments of the present invention, rotation unlocking mechanisms are disposed between the sliding members and the main frame. When the handle slides relative to the main body tube, the rotation unlocking mechanisms unlock or lock rotation of the handle relative to the sliding members.

In some embodiments of the present invention, a front insertion base is disposed on a front end of the main frame. A rear insertion base is disposed on a rear end of the main frame. When being inserted in the front insertion base, the handle is in the pull position. When being inserted in the rear insertion base, the handle is in the push position.

In some embodiments of the present invention, when the handle is in the pull position, the handle rotates relative to the main frame. When the handle is in the push position, the handle is fixed in the rear insertion base.

In some embodiments of the present invention, the accommodating space includes a first support surface and a second support surface lower than the first support surface, and the first support surface is for a child to ride; and/or the accommodating space includes a main body tube and a bottom frame, where the bottom frame supports the first support surface and the second support surface that have a height difference, and the main body tube approaches the bottom frame, to enable the main frame to be in the folded state.

According to an embodiment of a third aspect of the present invention, a stroller frame structure includes a main frame. The main frame has an unfolded state and a folded state, and is connected to a front wheel group and a rear wheel group. The main frame includes a bottom frame, a rear end frame, a main body tube, a seat assembly, and a handle. The main body tube is rotatably connected between the bottom frame and the rear end frame to form accommodating space together. The main body tube and the rear end frame approach each other relative to the bottom frame to form the folded state.

According to this embodiment of the present invention, the stroller frame structure has at least the following beneficial effects: A size of the stroller can be reduced, to facilitate storage and carrying.

In some embodiments of the present invention, the main body tube, the rear end frame, or the bottom frame is of a foldable structure.

In some embodiments of the present invention, the main body tube is of a foldable structure. The main body tube includes a first connection segment and a second connection segment. The first connection segment and the second connection segment are rotatably connected to each other by a rotation joint. The rotation joint is provided with an unlockable locking mechanism.

In some embodiments of the present invention, the handle is movably disposed at a push position or a pull position.

In some embodiments of the present invention, the handle is detachably disposed on the main frame.

When the handle is in the push position, the handle is close to the rear wheel group.

When the handle is in the pull position, the handle is close to the front wheel group.

In some embodiments of the present invention, the accommodating space includes a first support surface and a second support surface that have a height difference. The first support surface is for a child to ride on.

The seat assembly is located outside the accommodating space. When the seat assembly and the first support surface stagger in a vertical direction, both the seat assembly and the first support surface are for children to ride on.

### BRIEF DESCRIPTION OF DRAWINGS

The foregoing and/or additional aspects and advantages of the present invention become apparent and comprehensible from the following descriptions of embodiments with reference to the accompanying drawings.

FIG. 1 is a schematic diagram of a structure when a seat assembly of a stroller frame structure is located at a first position and a handle is located at a push position according to an embodiment of the present invention;

FIG. 2 is a schematic diagram of a structure when a seat assembly of a stroller frame structure is located at a second position and a handle is located at a push position according to an embodiment of the present invention;

FIG. 3 is a schematic diagram of a structure when a seat assembly of a stroller frame structure is located at a second position and a handle is located at a pull position according to an embodiment of the present invention;

FIG. 4 is a schematic diagram of a structure when a handle of a stroller frame structure is located at a push position according to an embodiment of the present invention;

FIG. 5 is a schematic diagram of a structure when a handle of a stroller frame structure switches from a push position to a pull position according to an embodiment of the present invention;

FIG. 6 is a schematic diagram of a structure when a handle of a stroller frame structure is located at a pull position according to an embodiment of the present invention;

FIG. 7 is a first schematic diagram of a structure when a handle of a stroller frame structure is controlled by a button according to an embodiment of the present invention;

FIG. 8 is a second schematic diagram of a structure when a handle of a stroller frame structure is controlled by a button according to an embodiment of the present invention;

FIG. 9 is a third schematic diagram of a structure when a handle of a stroller frame structure is controlled by a button according to an embodiment of the present invention;

FIG. 10 is a first schematic diagram of a structure when a handle of a stroller frame structure is controlled by an impact unlocking structure according to an embodiment of the present invention;

FIG. 11 is a second schematic diagram of a structure when a handle of a stroller frame structure is controlled by an impact unlocking structure according to an embodiment of the present invention;

FIG. 12 is a schematic diagram of a structure when a handle of a stroller frame structure is detachably mounted on a front end of a main frame according to an embodiment of the present invention;

FIG. 13 is a schematic diagram of a structure when a handle of a stroller frame structure is detachably mounted on a rear end of a main frame according to an embodiment of the present invention;

FIG. 14 is a schematic diagram of a structure of an unfolded state of a stroller frame structure according to an embodiment of the present invention;

FIG. 15 is a schematic diagram of a folding process of a stroller frame structure according to an embodiment of the present invention; and

FIG. 16 is a schematic diagram of a structure of a folded state of a stroller frame structure according to an embodiment of the present invention.

### REFERENCE NUMERALS

main frame 100, first support surface 101, second support surface 102, third support surface 103, main body tube 110, first connection segment 111, second connection segment 112, front insertion base 120, rear insertion base 130, front wheel group 140, rear wheel group 150, rear end frame 160, bottom frame 170;
seat assembly 200, support leg 210;
handle 400, sliding member 410, sliding unlocking button 411, rotation unlocking button 412, driving bump 413.

### DETAILED DESCRIPTION OF THE INVENTION

Embodiments of the present invention are described in detail below, and examples of the embodiments are shown in accompanying drawings, where same or similar elements or the elements having same or similar functions are denoted by the same or similar reference numerals throughout description. The embodiments described below with reference to the accompanying drawings are examples and are only used to interpret the present invention, instead limiting the present invention.

In the description of the present invention, it should be understood that orientation terms indicating orientation or position relationships, such as “up”, “down”, “front”, “back”, “left”, and “right”, are based on an orientation or position relationships shown in the accompanying drawings, and are only for ease and brevity of illustration and description, rather than indicating or implying that the mentioned apparatus or element needs to have a particular orientation or needs to be constructed and operated in a particular orientation. Therefore, such terms cannot be construed as a limitation of the present invention.

In the description of the present invention, terms “first” and “second” are merely for the purpose of distinguishing technical features, and cannot be understood as an indication or implication of relative importance or implicit indication of a quantity of indicated technical features or implicit indication a sequence of the indicated technical features.

In the description of the present invention, unless otherwise explicitly limited, terms such as “dispose”, “mount”, and “connect” should be understood in a broad sense, and a person skilled in the art may properly determine specific meanings of the foregoing terms in the present invention in combination with specific content of technical solutions.

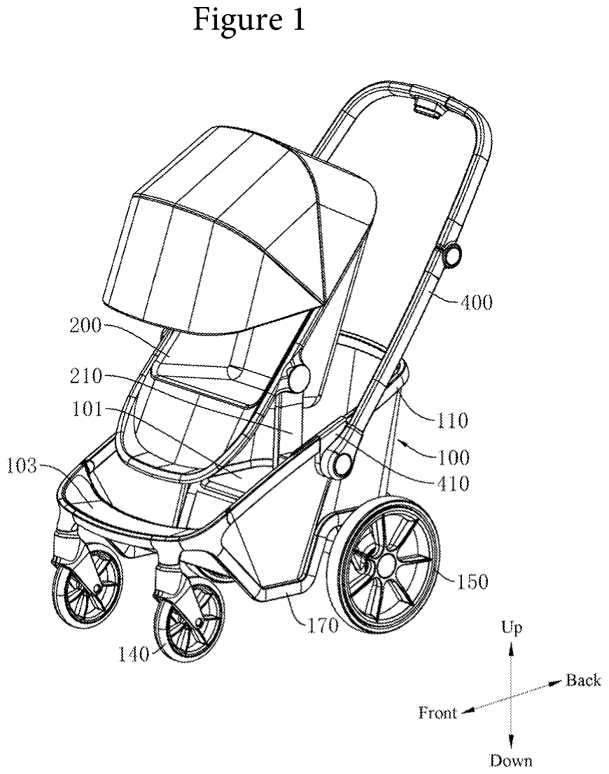

As shown in FIG. 1 to FIG. 16, according to an embodiment of the present invention, a stroller frame structure includes a main frame 100, a seat assembly 200, a handle 400. Both the seat assembly 200 and the handle 400 are disposed on the main frame 100. The main frame 100 has an unfolded state and a folded state, and is connected to a front wheel group 140 and a rear wheel group 150. The main frame 100 includes a first support surface 101 and a second support surface 102. The second support surface 102 is lower than the first support surface 101, to form a ridable structure having a height difference. The main frame 100 is used for forming a seat for a child to ride on, and a size of the stroller frame structure is smaller than a size of a conventional double stroller, to facilitate moving in small space or a place with dense people.

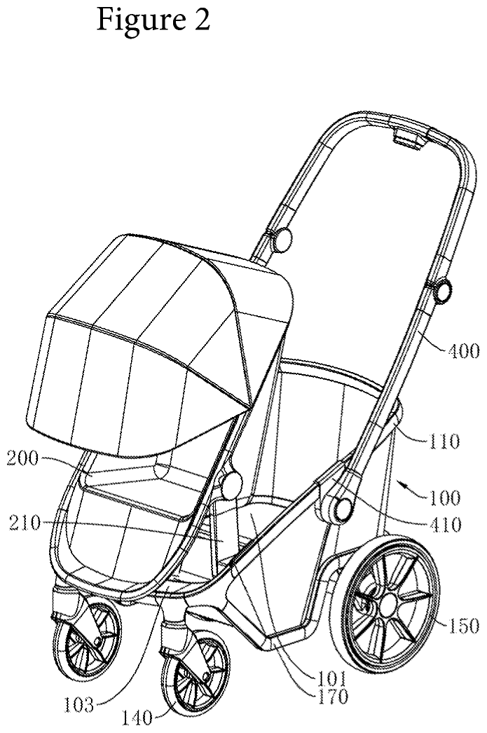

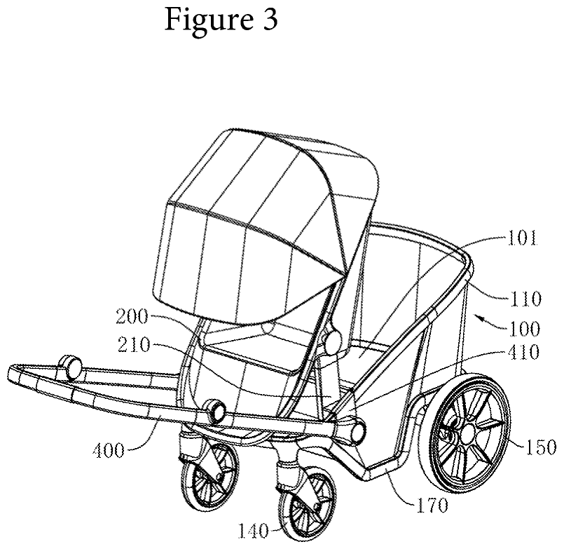

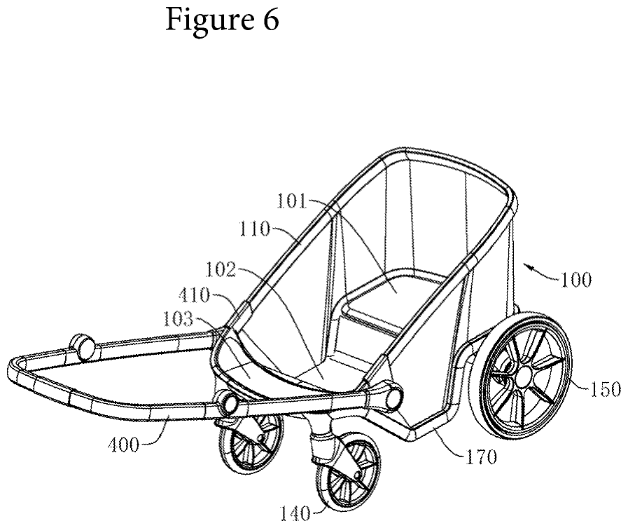

Specifically, as shown in FIG. 1, FIG. 2, FIG. 3, and FIG. 6, a storage basket is formed at the bottom of the main frame 100, and a frame of the storage basket is also a part of the main frame 100. By using the storage basket, a stroller frame has accommodating space of an annular structure. The first support surface 101 and the second support surface 102 are separately disposed in the accommodating space. The second support surface 102 is lower than the first support surface 101, to form a ridable structure having a height difference. In other words, a seat for a child is directly formed in the stroller frame. Compared with a size of a structure of which a seat of the conventional double stroller is directly mounted in a stroller frame, the size of the ridable structure is smaller.

It may be figured out that, in some embodiments of the present invention, the seat assembly 200 may be used for a child to ride on, and the ridable structure formed in the stroller frame may be used for another child to ride on. Therefore, a stroller that may be for two children to ride on can be formed.

It should be noted that, in some embodiments of the present invention, the ridable structure formed in the stroller frame may be used for placing objects, that is, used as a storage basket. In addition, the seat assembly 200 may be detached, so that the present invention may be used as a single stroller or a carrying trolley.

In some embodiments of the present invention, the handle 400 is movably disposed on the main frame 100, and the handle 400 slides along the main frame 100 to a push position and a pull position to implement functions of a trolley and a trailer respectively.

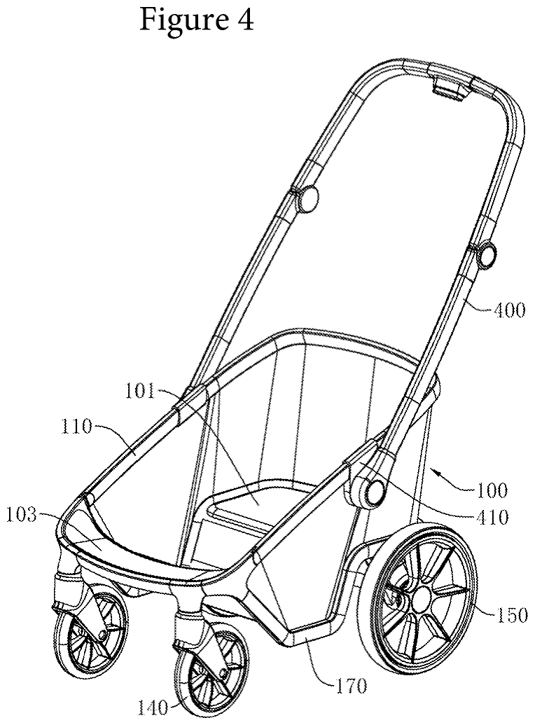

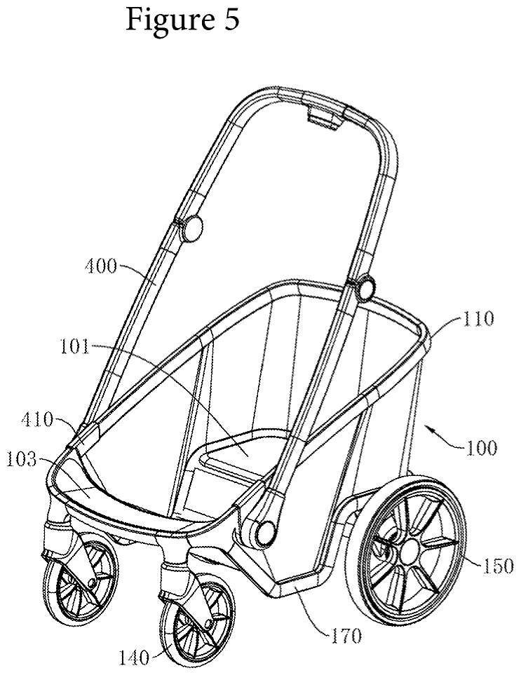

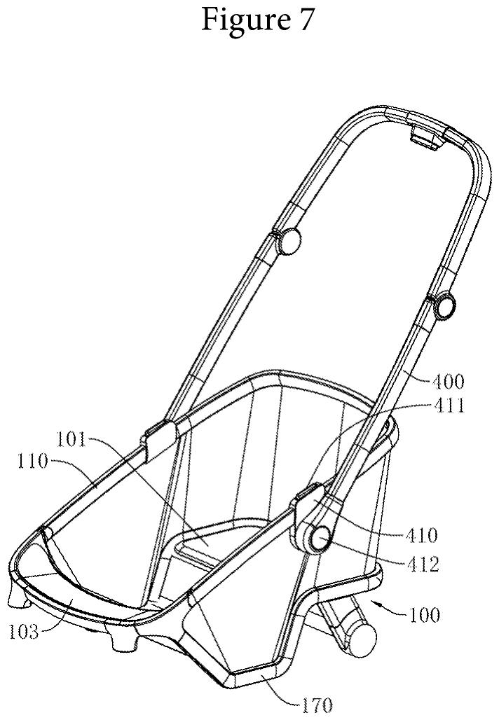

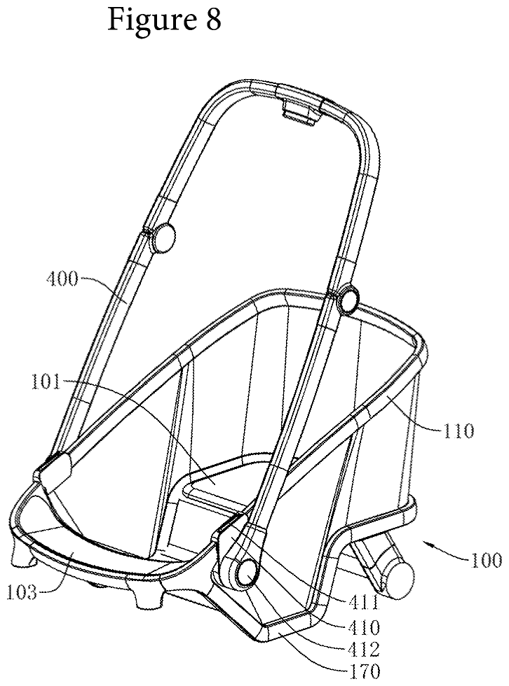

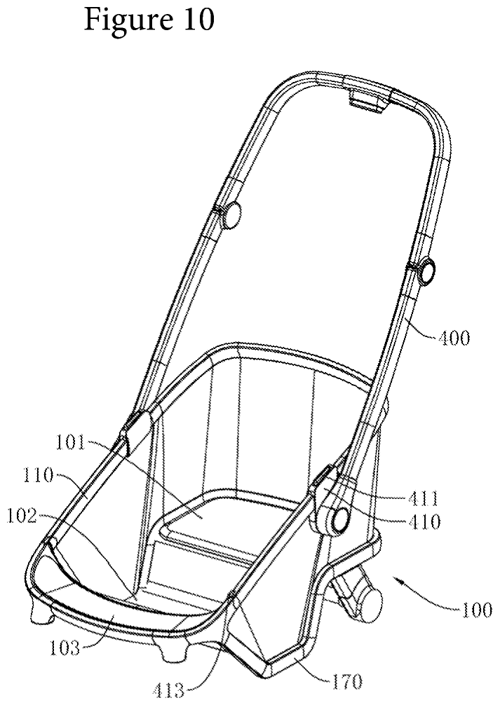

Specifically, the handle 400 is movably disposed on the main frame 100. As shown in FIG. 1, FIG. 2, FIG. 4, FIG. 5, FIG. 7, FIG. 8, and FIG. 10, the handle 400 is moved to the rear of the main frame 100, and is flipped backward. In other words, the handle 400 is located at the push position. In this case, the stroller may be used as a trolley.

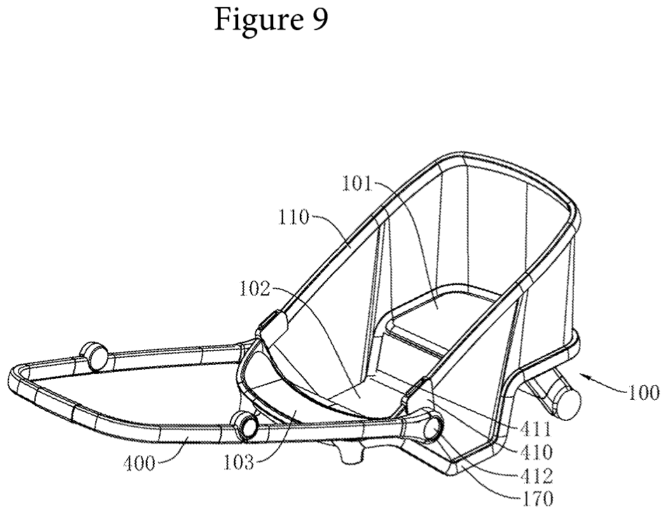

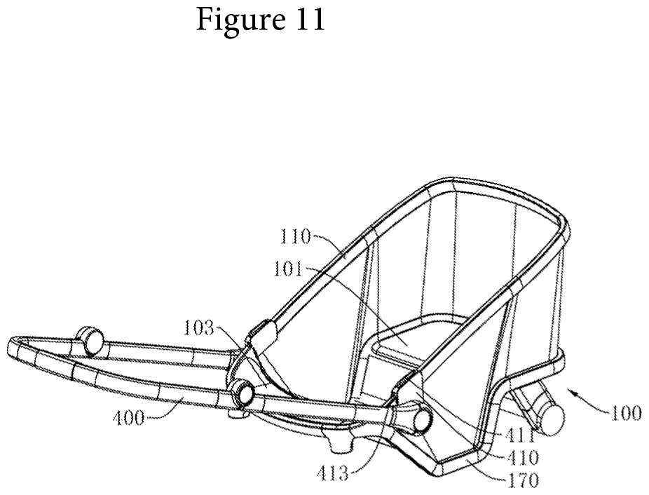

Specifically, as shown in FIG. 3, FIG. 6, FIG. 9, and FIG. 11, the handle 400 is moved to the front of the main frame 100, and may be flipped forward. In other words, the handle 400 is located at the pull position. In this case, the stroller may be used as a trailer.

In some embodiments of the present invention, the handle 400 is detachably disposed on the main frame 100 to enable the handle 400 to change a position between the pull position and the push position, to implement the functions of a trolley and a trailer respectively.

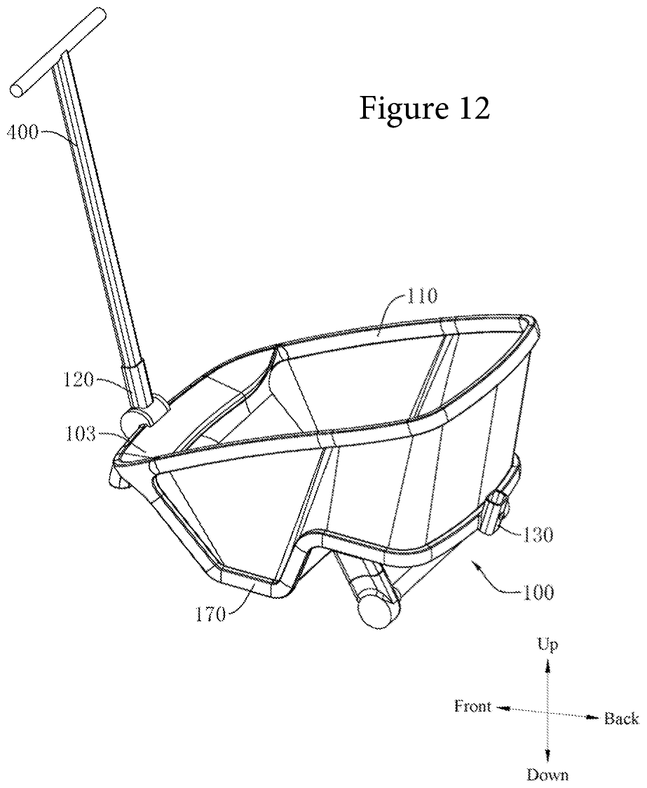

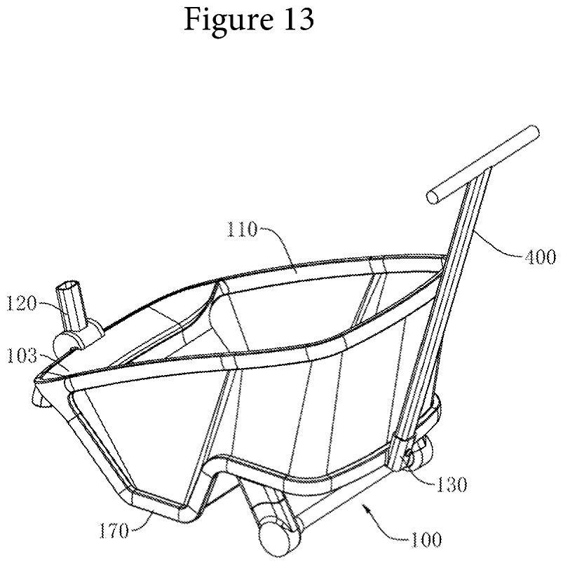

Specifically, the handle 400 is detachably disposed on the main frame 100. As shown in FIG. 12, a front insertion base 120 is disposed on a front end of the main frame 100, and an insertion opening of the front insertion base 120 is tilted forward. When the handle 400 is inserted into the front insertion base 120, the handle 400 is disposed on the front end of the main frame 100 and tilted forward and upward. In other words, the handle 400 is located at the pull position, so that the stroller can be used as a trailer. As shown in FIG. 13, a rear insertion base 130 is disposed on a rear end of the main frame 100, and an insertion opening of the rear insertion base 130 is tilted backward. When the handle 400 is inserted into the rear insertion base 130, the handle 400 is disposed on a rear front end of the main frame 100 and tilted backward and upward. In other words, the handle 400 is located at the push position, so that the stroller can be used as a trolley.

In some embodiments of the present invention, the push position is close to the rear wheel group 150, to facilitate pushing the stroller.

In some embodiments of the present invention, the pull position is close to the front wheel group 140, to facilitate pulling the stroller.

It may be figured out that, in some embodiments of the present invention, the main frame 100 has accommodating space. The accommodating space includes a bottom frame 170 and a main body tube 110. The main body tube 110 approaches the bottom frame 170 in a folded state, to enable the main frame 100 to be in the folded state, thereby facilitating stroller storage.

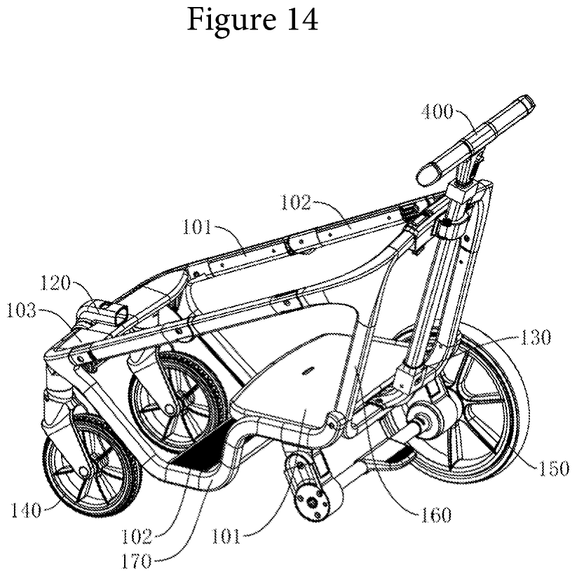

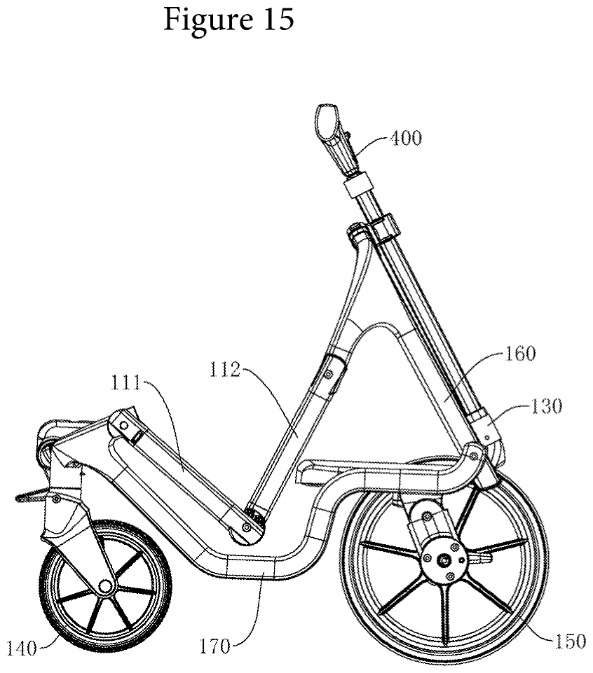

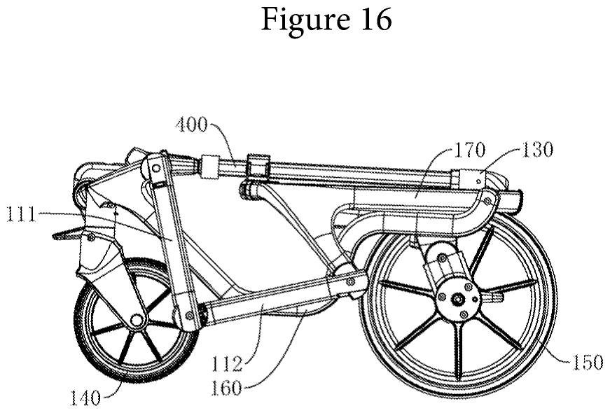

Specifically, as shown in FIG. 14, FIG. 15, and FIG. 16, the main body tube 110 includes a first connection segment 111 and a second connection segment 112. The first connection segment 111 and the second connection segment 112 are rotatably connected to each other by a rotation joint. The rotation joint is provided with an unlockable locking mechanism. The locking mechanism can lock the first connection segment 111 and the second connection segment 112 to a straight state to keep the stroller in an unfolded state. When the locking mechanism is unlocked, the first connection segment 111 and the rotation joint of the second connection segment 112 can move close to the bottom frame 170 to implement folding of the stroller.

It may be figured out that, in some embodiments of the present invention, the main body tube 110 is slidably disposed on the main frame 100. When being folded, the main body tube 110 slides close to the bottom frame 170 to implement a folding function.

It may be figured out that, in some embodiments of the present invention, the seat assembly 200 is located in front of the first support surface 101 for a first child to ride on. The first support surface 101 is for a second child to ride on.

Specifically, as shown in FIG. 2 and FIG. 3, by using the structure, the seat assembly 200 is located in front of a seat structure formed by the first support surface 101 and the second support surface 102, to enable the seat structure formed by the first support surface 101 and the second support surface 102 to have large seating space and a sight range, and facilitate entering and exiting of the second child.

It may be figured out that, in some embodiments of the present invention, the seat assembly 200 is detachably disposed on the main body tube 110 of the main frame 100, and can be mounted at a first position or a second position along the main body tube 110, to implement a change of a position of the seat assembly 200.

Specifically, as shown in FIG. 1, FIG. 2, and FIG. 3, the main body tube 110 extends from the front wheel group 140 to the rear wheel group 150. The first position of the seat assembly 200 is located at a middle position between the front wheel group 140 and the rear wheel group 150. The second position is close to the front wheel group 140, to enable the first support surface 101 to be for the second child to ride on.

It may be figured out that, in some embodiments of the present invention, the seat assembly 200 may alternatively be disposed to be slidably mounted to the main body tube 110, and a change of a position is implemented by a sliding pair.

In some embodiments of the present invention, the main frame 100 is of a low front and high rear structure to enable the seat assembly 200 to be raised or lowered, so that a height position can be adjusted by using the seat assembly 200 to implement different sight ranges or form a variety of stroller forms.

Specifically, in FIG. 1, the seat assembly 200 is moved to the middle of the main frame 100, that is, the first position, and is in a high position in the stroller, and a child seating in the seat assembly 200 may get a better view. The bottom of the main frame 100 may be used as a storage basket. In FIG. 2, the seat assembly 200 is moved to the front of the main frame 100, that is, the second position, and is in a low position of the stroller, to enable the seat structure formed by the first support surface 101 and the second support surface 102 to have a better view and seating space. In this case, an overall height of the stroller is lowered. Parking of the stroller can be convenient.

In some embodiments of the present invention, the main frame 100 is provided with the main body tube 110 tilted upwards from front to back. The seat assembly 200 is slidably or detachably disposed on the main body tube 110. A height position and a horizontal position can be adjusted by adjusting a position of the seat assembly 200.

Specifically, as shown in FIG. 1, FIG. 2, and FIG. 3, the main body tube 110 is obliquely disposed on an upper part of the main frame 100. The main body tube 110 is a main supporting tube of the main frame 100, and has a high bearing capacity, so that when the seat assembly 200 is slidably or detachably disposed on the main body tube 110, better structural stability can be obtained.

In some embodiments of the present invention, as shown in FIG. 1, FIG. 2, and FIG. 3, two ends of the seat assembly 200 are respectively extended downwards and are provided with support legs 210. Each support leg 210 is provided with a buckle mounting structure that can be buckled to the main body tube 110 and is slidably matched with or detachably connected to the main body tube 110, so that the seat assembly 200 is mounted on the main body tube 110.

It may be figured out that, lower ends of the support legs 210 can also be provided with sliding members slidably matched with the main body tube 110, and a function of slidably mounting the seat assembly 200 can also be implemented.

It may be figured out that, in some embodiments of the present invention, positioning mechanisms are disposed between the seat assembly 200 and the main frame 100 to position the position of the seat assembly 200. Specifically, as shown in FIG. 1, FIG. 2, and FIG. 3, each positioning mechanism may be disposed between each buckle mounting structure and the main body tube 110, may be a latch-positioning mechanism, a marble-positioning mechanism, and the like, and may perform control by a button, a knob, a wrench, or the like.

It may be figured out that, in some embodiments of the present invention, the seat assembly 200 may be reversibly disposed on the main frame 100, so that an orientation of the seat assembly 200 can be adjusted.

Specifically, in FIG. 1, FIG. 2, and FIG. 3, the seat assembly 200 is disposed to face forward. In specific use, the seat assembly 200 may be turned to face back as needed. Specifically, a reversing function of the seat assembly 200 may be implemented by connecting the support legs 210 to the seat assembly 200 in a rotatable manner.

It may be figured out that, in some embodiments of the present invention, the main frame 100 includes a third support surface 103 located at a leading edge of the main frame 100 or close to the second support surface 102 for the second child to step on, to improve comfort of seating.

It may be figured out that, in some embodiments of the present invention, the main frame 100 forms accommodating space. The first support surface 101 and the second support surface 102 form a bottom of the accommodating space together.

Specifically, as shown in FIG. 6, an inner side of the main frame 100 forms the accommodating space being used for carrying objects or for the second child to ride on. The first support surface 101 and the second support surface 102 form the bottom of the accommodating space together.

It may be figured out that, in some embodiments of the present invention, the main frame 100 includes a main body tube 110 and a rear end frame 160. One end of the main body tube 110 is connected to the second support surface 102, and the other end of the main body tube 110 is connected to the first support surface 101 through the rear end frame 160.

Specifically, as shown in FIG. 14, the front end of the main body tube 110 is connected to the second support surface 102 by a lower extension frame to have high structural strength. The rear end of the main body tube 110 is connected to the first support surface 101 by the rear end frame 160 to have high structural strength. By using the foregoing structure, a seat structure with good structural strength may be formed in the main frame 100.

According to an embodiment of a second aspect of the present invention, a stroller frame structure includes a main frame 100, a seat assembly 200, and a handle 400. The seat assembly 200 is disposed on the main frame 100. The main frame 100 has an unfolded state and a folded state, and is connected to a front wheel group 140 and a rear wheel group 150. The main frame 100 includes accommodating space. The handle 400 may be moved to a push position close to the rear wheel group 150 and to a pull position close to the front wheel group 140, to implement functions of pushing the stroller and pulling the stroller.

Specifically, as shown in FIG. 1, FIG. 2, FIG. 4, FIG. 5, FIG. 7, FIG. 8, FIG. 10, and FIG. 13, the handle 400 is moved to the rear of the main frame 100, and is flipped backward. In other words, the handle 400 is located at the push position. In this case, the stroller may be used as a trolley.

Specifically, as shown in FIG. 3, FIG. 6, FIG. 9, FIG. 11, and FIG. 12, the handle 400 is moved to the front of the main frame 100, and may be flipped forward. In other words, the handle 400 is located at the pull position. In this case, the stroller may be used as a trailer.

It may be figured out that, in some embodiments of the present invention, the handle 400 is located between the push position and the pull position and is slidable along the main frame 100, and the handle 400 may rotate relative to the main frame 100 to adjust a position and a state of the handle 400.

As shown in FIG. 7 to FIG. 11, in some embodiments of the present invention, the main frame 100 includes a main body tube 110 located on both sides of the main frame 100. The handle 400 is moved between the push position and the pull position along the main body tube 110. When the handle 400 is located at the push position, the handle 400 is locked to prevent rotation relative to the main frame to push the stroller stably. When the handle 400 is located at the pull position, the handle 400 is unlocked to allow rotation relative to the main frame 100 to enable the handle 400 to swing up and down when the stroller is pulled, to adapt to a pace of a trailer personnel.

It may be figured out that, in some embodiments of the present invention, when the handle 400 is located at the pull position, the handle 400 is locked to prevent rotation relative to the main frame 100 to locate the handle 400 to a set height.

It may be figured out that, in some embodiments of the present invention, the handle 400 is slidingly connected to the main body tube 110 by sliding members 410 in a position-limitable manner. The handle 400 is rotatably connected to the sliding members 410 in a rotation-lockable manner, to locate a front position, a rear position, an up position, and a down position of the handle 400.

It may be figured out that, in some embodiments of the present invention, rotation unlocking mechanisms are disposed between the sliding members 410 and the main frame 100. When the handle 400 slides relative to the main body tube 110, the rotation unlocking mechanisms unlock or lock rotation of the handle 400 relative to the sliding members 410, to avoid a second operation of a user.

In some embodiments of the present invention, as shown in FIG. 7, FIG. 8, FIG. 9, FIG. 10, and FIG. 11, the sliding members 410 are provided with sliding unlocking buttons 411. Sliding-positioning members, such as latches and clamping members, are disposed between the sliding members 410 and the main body tube 110. Each sliding-positioning member has a lock position and an unlock position. When the sliding unlocking buttons 411 are not pressed, the sliding-positioning members are kept at the lock position by elastic members, and the sliding members 410 are locked in the main body tube 110. The sliding unlocking buttons 411 are pressed to drive the sliding-positioning members to move to the unlock position, and the sliding members 410 may slide relative to the main body tube 110.

The user may move the handle 400 to the front end, the middle, and the rear end of the main body tube 110 by the sliding members 410, and finally release the sliding unlocking buttons 411, to enable the handle 400 to be located at a set position.

Specifically, the main body tube 110 may be provided with holes or slots corresponding to the sliding-positioning members, such as latches and clamping members, to locate positions of the sliding members 410.

It may be figured out that sliding-positioning mechanisms may alternatively perform control by knobs, and position of the sliding-positioning members are changed by rotating the knobs, to implement the function of sliding positioning.

In some embodiments of the present invention, as shown in FIG. 7, FIG. 8, and FIG. 9, the sliding members 410 are provided with rotation unlocking buttons 412. Rotation-positioning members, such as latches and locating pieces, are disposed between the handle 400 and the sliding members 410. Each rotation-positioning member has a lock position and an unlock position. When the rotation unlocking buttons 412 are not pressed, the rotation-positioning members are kept at the lock position by elastic members, and relative angles of the handle 400 to the sliding members 410 are locked. The rotation unlocking buttons 412 are pressed to drive the rotation-positioning members to move to the unlock position. The handle 400 may rotate relative to the sliding members 410. The user may turn the handle 400 to a position facing forward, and the stroller may be used as a trailer in this case.

Specifically, the handle 400 or each sliding member 410 is provided with a rotation disk. The rotation-positioning members, such as latches and locating pieces, are correspondingly disposed on the sliding members 410 and the handle 400. When the rotation-positioning members are at the lock position, the rotation-positioning members, such as latches and locating pieces, are clamped with the rotation disks, to locate the relative angles of the handle 400 to the sliding members 410. When the rotation-positioning members are at the unlock position, the rotation-positioning members, such as latches and locating pieces, and the rotation disk are separated from each other and unlocked, to enable the handle 400 to rotate relative to the sliding members 410.

In some embodiments of the present invention, as shown in FIG. 10 and FIG. 11, rotation-positioning members, such as latches and locating pieces, are disposed between the handle 400 and the sliding members 410. The front end of the main body tube 110 is provided with driving bumps 413. Each sliding member 410 has an avoiding opening for each driving bump 413 to be inserted into. Each rotation-positioning member has a lock position and an unlock position. When the sliding members 410 are located in a middle and rear segment of the main body tube 110, the handle 400 is flipped backward to form a trolley structure. In this case, the rotation-positioning members are kept at the lock position due to effect of elastic member. When the sliding members 410 slide to the front end of the main body tube 110, the driving bumps 413 are inserted into the sliding members 410 by the avoiding openings, and the rotation-positioning members are driven to the unlock position. The handle 400 may rotate relative to the sliding members 410. The user may turn the handle 400 to a position facing forward, and the stroller may be used as a trailer in this case.

It may be figured out that the rotation-positioning mechanisms may alternatively control positions of a rotation-positioning member by wrenches, knobs, and the like, to implement control of rotation angles of the handle 400.

It may be figured out that, the handle 400 is detachably disposed at the push position or the pull position, to adjust a position and a state of the handle 400.

Specifically, the handle 400 is detachably disposed on the main frame 100. As shown in FIG. 12, a front insertion base 120 is disposed on a front end of the main frame 100, and an insertion opening of the front insertion base 120 is tilted forward. When the handle 400 is inserted into the front insertion base 120, the handle 400 is disposed on the front end of the main frame 100 and tilted forward and upward. In other words, the handle 400 is located at the pull position, so that the stroller can be used as a trailer. As shown in FIG. 13, a rear insertion base 130 is disposed on a rear end of the main frame 100, and an insertion opening of the rear insertion base 130 is tilted backward. When the handle 400 is inserted into the rear insertion base 130, the handle 400 is disposed on a rear front end of the main frame 100 and tilted backward and upward. In other words, the handle 400 is located at the push position, so that the stroller can be used as a trolley.

It may be figured out that, in some embodiments of the present invention, the lower end of the handle 400 may be inserted into an insertion groove of the front insertion base 120 or an insertion groove of the rear insertion base 130. In addition, each insertion groove is provided with a locking mechanism that can locate the handle 400. The locking mechanism may be a buckle mechanism, a latch mechanism, a marble mechanism, and the like, and may perform control by a button, a wrench, a self-locking mechanism, and the like, to improve reliability of connections between the handle 400 and the front insertion base 120 as well as the handle 400 and the rear insertion base 130.

It may be figured out that, the front insertion base 120 may rotates relative to the main frame 100, to facilitate the user to pull the stroller.

Specifically, when the handle 400 is at the pull position, the handle 400 may rotate relative to the main frame 100, to enable the handle 400 to swing up and down when the stroller is pulled, to adapt to a pace change of a trailer personnel. When the handle 400 is at the push position, the handle 400 is fixed in the rear insertion base 130 to form a stable trolley structure.

It may be figured out that, in some embodiments of the present invention, the main frame 100 forms accommodating space. The accommodating space includes a first support surface 101 and a second support surface 102 lower than the first support surface 101, and the first support surface 101 is for a child to ride on.

Specifically, the first support surface 101 and the second support surface 102 form a bottom of the accommodating space together that forms a seat structure having high and low coordination and that may be used for carrying objects or for the second child to ride on.

It may be figured out that, in some embodiments of the present invention, the accommodating space includes a main body tube 110 and a bottom frame 170. The bottom frame 170 supports the first support surface 101 and the second support surface 102 that have a height difference. The main body tube 110 approaches the bottom frame 170, to enable the main frame 100 to be in the folded state, to facilitate folding the stroller.

According to an embodiment of a third aspect of the present invention, a stroller frame structure includes a main frame 100. The main frame 100 has an unfolded state and a folded state, and is connected to a front wheel group 140 and a rear wheel group 150. The main frame 100 includes a bottom frame 170, a rear end frame 160, a main body tube 110, a seat assembly 200, and a handle 400. The main body tube is rotatably connected between the bottom frame 170 and the rear end frame 160 to form accommodating space together. The main body tube 110 and the rear end frame 160 approach each other relative to the bottom frame 170 to form the folded state, to reduce a size of the stroller to facilitate storage and carrying.

It may be figured out that, in some embodiments of the present invention, the main body tube 110, the rear end frame 160, or the bottom frame 170 is of a foldable structure, to implement the foregoing folding function.

As shown in FIG. 14 to FIG. 16, in some embodiments of the present invention, the main body tube 110 is of a foldable structure. The main body tube 110 includes a first connection segment 111 and a second connection segment 112. The first connection segment 111 and the second connection segment 112 are rotatably connected to each other by a rotation joint. The rotation joint is provided with an unlockable locking mechanism. The locking mechanism can lock the first connection segment 111 and the second connection segment 112 to a straight state to keep the stroller in an unfolded state. When the locking mechanism is unlocked, the first connection segment 111 and the rotation joint of the second connection segment 112 can move close to the bottom frame 170 to implement folding of the stroller.

Specifically, the locking mechanism may be of a latch-locating structure, a slot-locating structure, or the like. It may be figured out that, in some embodiments of the present invention, the rear end frame 160 or the bottom frame 170 may also be disposed as a foldable structure, or may be formed as a multi-link mechanism, to implement folding of the stroller frame.

It may be figured out that, in some embodiments of the present invention, the handle 400 is movably disposed at a push position or a pull position, to implement functions of a trolley and a trailer.

It may be figured out that, in some embodiments of the present invention, the handle 400 is detachably disposed on the main frame 100. When the handle 400 is at the push position, the handle 400 is close to the rear wheel group 150. When the handle 400 is at the pull position, the handle 400 is close to the front wheel group 140. By using the handle 400 of a detachable structure, the functions of a trolley and a trailer is implemented.

It may be figured out that, in some embodiments of the present invention, the accommodating space includes a first support surface 101 and a second support surface 102 that have a height difference. The first support surface 101 is for a child to ride on.

Specifically, the seat assembly 200 is located outside the accommodating space. As shown in FIG. 2 and FIG. 3, when the seat assembly 200 and the first support surface 101 stagger in a vertical direction, both the seat assembly 200 and the first support surface 101 are for children to ride on. In addition, in this case, the child who rides on the first support surface 101 has a better view and large space for entering and exiting. Certainly, the present invention is not limited to the foregoing embodiments. A person skilled in the art may also make equivalent variations or replacements without violating the spirit of the present invention, and these equivalent variations or replacements fall within the scope limited by the claims of this application.

1. A stroller frame structure, comprising:
a main frame (100), having an unfolded state and a folded state, and being connected to a front wheel group (140) and a rear wheel group (150), wherein the main frame (100) comprises a first support surface (101) and a second support surface (102), and the second support surface (102) is lower than the first support surface (101);
a seat assembly (200), wherein the seat assembly (200) is disposed on the main frame (100); and
a handle (400), disposed on the main frame (100).

2. The stroller frame structure according to claim 1, wherein
the handle (400) is movably disposed on the main frame (100), and the handle (400) slides along the main frame (100) to a push position and a pull position;
or
the handle (400) is detachably disposed on the main frame (100) to enable the handle (400) to change a position between a push position and a pull position.

3. The stroller frame structure according to claim 2, wherein
the push position is close to the rear wheel group (150), and the pull position is close to the front wheel group (140).

4. The stroller frame structure according to claim 1, wherein
the main frame (100) has accommodating space, the accommodating space comprises a bottom frame (170) and a main body tube (110), and the main body tube (110) approaches the bottom frame (170) in a folded state, to enable the main frame (100) to be in the folded state.

5. The stroller frame structure according to claim 1, wherein
the seat assembly (200) is located in front of the first support surface (101) for a first child to ride on, and the first support surface (101) is for a second child to ride on.

6. The stroller frame structure according to claim 1, wherein
the seat assembly (200) is detachably disposed on a main body tube (110) of the main frame (100), and is mounted at a first position or a second position along the main body tube (110).

7. The stroller frame structure according to claim 6, wherein
the first position of the seat assembly (200) is located at a middle position between the front wheel group (140) and the rear wheel group (150), and the second position is close to the front wheel group (140), to enable the first support surface (101) to be for a second child to ride on.

8. The stroller frame structure according to claim 1, wherein
the main frame (100) comprises a third support surface (103) for a child to step on, and the third support surface is located at a leading edge of the main frame (100) or a position close to the second support surface (102).

9. The stroller frame structure according to claim 1, wherein
the main frame (100) forms accommodating space, wherein
the first support surface (101) and the second support surface (102) form a bottom of the accommodating space together;
and/or
the main frame (100) comprises a main body tube (110) and a rear end frame (160), one end of the main body tube (110) is connected to the second support surface (102), and the other end of the main body tube (110) is connected to the first support surface (101) through the rear end frame (160).

10. A stroller frame structure, comprising:
a main frame (100), having an unfolded state and a folded state, and being connected to a front wheel group (140) and a rear wheel group (150), wherein the main frame (100) comprises accommodating space;
a seat assembly (200), disposed on the main frame (100); and
a handle (400), wherein the handle (400) is moved to a push position close to the rear wheel group (150) and to a pull position close to the front wheel group (140).

11. The stroller frame structure according to claim 10, wherein
the handle (400) is located between the push position and the pull position and is slidable along the main frame (100), and the handle (400) rotates relative to the main frame (100);
or
the handle (400) is detachably disposed at the push position or the pull position.

12. The stroller frame structure according to claim 10, wherein
the main frame (100) comprises a main body tube (110) located on both sides of the main frame (100), and the handle (400) is moved between the push position and the pull position along the main body tube (110);
when the handle (400) is located at the push position, the handle (400) is locked to prevent rotation relative to the main frame; and
when the handle (400) is located at the pull position, the handle (400) is unlocked to allow rotation relative to the main frame (100).

13. The stroller frame structure according to claim 12, wherein
the handle (400) is slidingly connected to the main body tube (110) by sliding members (410) in a position-limitable manner, and the handle (400) is rotatably connected to the sliding members (410) in a rotation-lockable manner.

14. The stroller frame structure according to claim 13, wherein
rotation unlocking mechanisms are disposed between the sliding members (410) and the main frame (100), and when the handle (400) slides relative to the main body tube (110), the rotation unlocking mechanisms unlock or lock rotation of the handle (400) relative to the sliding members (410).

15. The stroller frame structure according to claim 10, wherein
a front insertion base (120) is disposed on a front end of the main frame (100), a rear insertion base (130) is disposed on a rear end of the main frame (100), when being inserted in the front insertion base (120), the handle (400) is located at the pull position, and when being inserted in the rear insertion base (130), the handle (400) is located at the push position.

16. The stroller frame structure according to claim 15, wherein
when the handle (400) is in the pull position, the handle (400) rotates relative to the main frame (100), and when the handle (400) is in the push position, the handle (400) is fixed in the rear insertion base (130).

17. The stroller frame structure according to claim 10, wherein
the accommodating space comprises a first support surface (101) and a second support surface (102) lower than the first support surface (101), and the first support surface (101) is for a child to ride on;
and/or
the accommodating space comprises a main body tube (110) and a bottom frame (170), wherein the bottom frame (170) supports the first support surface (101) and the second support surface (102) that have a height difference, and the main body tube (110) approaches the bottom frame (170), to enable the main frame (100) to be in the folded state.

18. A stroller frame structure, comprising a main frame (100), wherein the main frame (100) has an unfolded state and a folded state, and is connected to a front wheel group (140) and a rear wheel group (150); and the main frame (100) comprises:
a bottom frame (170);
a rear end frame (160);
a main body tube (110), rotatably connected between the bottom frame (170) and the rear end frame (160) to form accommodating space together, wherein the main body tube (110) and the rear end frame (160) approach each other relative to the bottom frame (170) to form the folded state;
a seat assembly (200), disposed on the main frame (100); and
a handle (400), disposed on the main frame (100).

19. The stroller frame structure according to claim 18, wherein
the main body tube (110), the rear end frame (160), or the bottom frame (170) is of a foldable structure.

20. The stroller frame structure according to claim 19, wherein
the main body tube (110) is of a foldable structure, the main body tube (110) comprises a first connection segment (111) and a second connection segment (112), the first connection segment (111) and the second connection segment (112) are rotatably connected to each other by a rotation joint, and the rotation joint is provided with an unlockable locking mechanism.

21. The stroller frame structure according to claim 18, wherein
the handle (400) is movably disposed at a push position or a pull position.

22. The stroller frame structure according to claim 21, wherein
the handle (400) is detachably disposed on the main frame (100);
when the handle (400) is in the push position, the handle (400) is close to the rear wheel group (150); and
when the handle (400) is in the pull position, the handle (400) is close to the front wheel group (140).

23. The stroller frame structure according to claim 18, wherein
the accommodating space comprises a first support surface (101) and a second support surface (102) that have a height difference, and the first support surface (101) is for a child to ride on; and
the seat assembly (200) is located outside the accommodating space, and when the seat assembly (200) and the first support surface (101) stagger in a vertical direction, both the seat assembly (200) and the first support surface (101) are for children to ride on.
